(19) United States
(12) Patent Application Publication
(10) Pub. No.: US 2026/0150169 A1
(43) Pub. Date: May 28, 2026

(54) REAL-TIME CONTROL OF LIGHTING EFFECTS

(71) Applicant: Gregory Notaro, New Boston, NH (US)

(72) Inventor: Gregory Notaro, New Boston, NH (US)

(21) Appl. No.: 19/171,480

(22) Filed: Apr. 7, 2025

Related U.S. Application Data
(60) Provisional application No. 63/575,759, filed on Apr. 7, 2024.

(51) Int. Cl. H05B 47/12; H05B 47/18

(52) U.S. Cl. CPC H05B 47/12; H05B 47/184

(57) ABSTRACT

Examples include at least one non-transitory computer-readable medium storing instructions for operating a lighting system including first and second lighting fixtures, the instructions configured to instruct at least one processor to receive a first user input including lighting-fixture profile information, and, in real time, process an audio signal from an audio input to identify one or more characteristic parameters of the audio input, identify a lighting effect based on the profile information and the characteristic parameters, determine a trigger signal based on the processing and/or a second user input, manipulate the lighting effect based on the trigger signal, generate at least one lighting effect signal based on the manipulating, provide the at least one lighting effect signal to the lighting fixtures to cause the first lighting fixture to take a first action and causing the second lighting fixture to take a second action different than the first action.

### CROSS-REFERENCE TO RELATED APPLICATIONS

This application claims priority under 35 U.S.C. § 119(e) to U.S. Provisional Application Ser. No. 63/575,759, titled “AUTONOMOUS DMX LIGHTING CONTROLLER AND METHODS HEREIN,” filed on Apr. 7, 2024, which is hereby incorporated by reference in its entirety.

### BACKGROUND

### 1. Field of the Disclosure

At least one example in accordance with the present disclosure relates generally to a lighting control system configured to control lighting fixtures to generate lighting effects.

### 2. Discussion of Related Art

Lighting fixtures, such as light-emitting-diode (LED) bars, LED moving heads, gobos, and light projectors, may be used to produce various lighting effects. It may be desirable to adapt the lighting effects according to the specific needs of the occasion or users. A lighting control system may be used to generate control signals and transmit the control signals to the lighting fixtures to change or select the light effects. Certain types of lighting fixtures may require a communication protocol for the transmission of control signals.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure, at least one non-transitory computer-readable medium storing thereon sequences of computer-executable instructions for operating a lighting system including a plurality of lighting fixtures is provided, the plurality of lighting fixtures including a first lighting fixture and a second lighting fixture different than the first lighting fixture, the sequences of computer-executable instructions including instructions that instruct at least one processor to receive a first user input including profile information relating to the plurality of lighting fixtures; receive an audio input from an audio source; process the audio input in real time, the processing including identifying one or more characteristic parameters of the audio input; identify, in real time, a lighting effect of the plurality of lighting fixtures based on the profile information and the one or more characteristic parameters; determine, in real time, a trigger signal based on at least one of the processing of the audio input or a second user input; manipulate, in real time, the lighting effect based on the trigger signal; generate, in real time, at least one lighting effect signal based at least in part on the manipulating of the lighting effect; and provide, in real time, the at least one lighting effect signal to the plurality of lighting fixtures to operate the plurality of lighting fixtures in real time, wherein operating the plurality of lighting fixtures in real time includes causing the first lighting fixture to take a first action and causing the second lighting fixture to take a second action different than the first action.

In at least one example, operating the plurality of lighting fixtures in real time includes synchronizing the first action and the second action. In at least one example, the first action and the second action are selected from a group including changing a lighting color, changing a lighting brightness, changing a strobe frequency, and/or panning and/or tilting a moving head, a gobo, a light filter, a zoom lens, and/or a laser. In at least one example, identifying, in real time, the lighting effect includes adapting, in real time, an adaptable lighting effect stored in an adaptable effect library. In at least one example, manipulating, in real time, the lighting effect based on the trigger signal includes synchronizing, in real time, the lighting effect and the trigger signal. In at least one example, the profile information includes respective location information of the plurality of lighting fixtures.

In at least one example, processing the audio input in real time is performed based at least in part on real-time analog signal processing. In at least one example, the first lighting fixture is of a first type, the second lighting fixture is of a second type different from the first type, and the profile information includes the first type and the second type. In at least one example, providing, in real time, the at least one lighting effect signal to the plurality of lighting fixtures includes transmitting the lighting effect signal to the plurality of lighting fixtures using a digital multiplex (DMX) protocol. In at least one example, at least a subset of the plurality of lighting fixtures are coupled in series.

Aspects of the disclosure include a lighting control system, comprising: a communication interface configured to be coupled to a user interface; an audio input configured to be coupled to an audio source; a control signal output configured to be coupled to a plurality of lighting fixtures including a first lighting fixture and a second lighting fixture different than the first lighting fixture; and at least one controller coupled to the communication interface, the audio input, and the control signal output and configured to: receive, via the communication interface, a first user input including profile information relating to the plurality of lighting fixtures; receive, via the audio input, an audio signal from an audio source; process the audio signal in real time, the processing including identifying one or more characteristic parameters of the audio signal; identify, in real time, a lighting effect of the plurality of lighting fixtures based on the profile information and the one or more characteristic parameters; determine, in real time, a trigger signal based on at least one of the processing of the audio signal or a second user input; manipulate, in real time, the lighting effect based on the trigger signal; generate, in real time, at least one lighting effect signal based at least in part on the manipulating of the lighting effect; and provide, in real time, the at least one lighting effect signal to the plurality of lighting fixtures to operate the plurality of lighting fixtures in real time, wherein operating the plurality of lighting fixtures in real time includes causing the first lighting fixture to take a first action and causing the second lighting fixture to take a second action different than the first action.

In at least one example, the audio input is a microphone. In at least one example, operating the plurality of lighting fixtures in real time includes synchronizing the first action and the second action. In at least one example, the first action and the second action are selected from a group including changing a lighting color, changing a lighting brightness, changing a strobe frequency, and/or panning and/or tilting a moving head, a gobo, a light filter, a zoom lens, and/or a laser. In at least one example, identifying, in real time, the lighting effect includes adapting, in real time, an adaptable lighting effect stored in an adaptable effect library. In at least one example, manipulating, in real time, the lighting effect based on the trigger signal includes synchronizing, in real time, the lighting effect and the trigger signal.

In at least one example, processing the audio input in real time is performed based at least in part on real-time analog signal processing. In at least one example: the plurality of lighting fixtures includes a first lighting fixture of a first type and a second lighting fixture of a second type different from the first type, and the profile information includes the first type and the second type. In at least one example, providing, in real time, the at least one lighting effect signal to the plurality of lighting fixtures includes transmitting, in real time, the lighting effect signal to the plurality of lighting fixtures using a digital multiplex (DMX) protocol.

Aspects of the disclosure include a method of operating a lighting system including a plurality of lighting fixtures, the plurality of lighting fixtures including a first lighting fixture and a second lighting fixture different than the first lighting fixture, the method comprising: receiving a first user input including profile information relating to the plurality of lighting fixtures; receiving an audio input from an audio source; processing the audio input in real time, the processing including identifying one or more characteristic parameters of the audio input; identifying, in real time, a lighting effect of the plurality of lighting fixtures based on the profile information and the one or more characteristic parameters; determining, in real time, a trigger signal based on at least one of the processing of the audio input or a second user input; manipulating, in real time, the lighting effect based on the trigger signal; generating, in real time, at least one lighting effect signal based at least in part on the manipulating of the lighting effect; and providing, in real time, the at least one lighting effect signal to the plurality of lighting fixtures to operate the plurality of lighting fixtures in real time, wherein operating the plurality of lighting fixtures in real time includes causing the first lighting fixture to take a first action and causing the second lighting fixture to take a second action different than the first action.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram of a lighting control system according to an example;

FIG. 2 illustrates a process of operating the lighting control system of FIG. 1 according to an example; and

FIG. 3 illustrates another process of operating the lighting control system of FIG. 1 according to an example.

### DETAILED DESCRIPTION

The present disclosure relates to controlling lighting fixtures, systems, devices, or apparatuses compatible with digital multiplex (DMX) communication protocols, such as DMX512, DMX512-A, and other communication protocols. Examples of the lighting fixtures may be designed for event-based applications, commercial or industrial architectural applications, automotive, entertainment, and other applications where various lighting effects may be needed. In some of the applications, real-time or dynamic adjustment and production of the lighting effects may be desired according to the specific lighting fixtures used, their relative locations in the arena of the event, and the preferences of a user or observers.

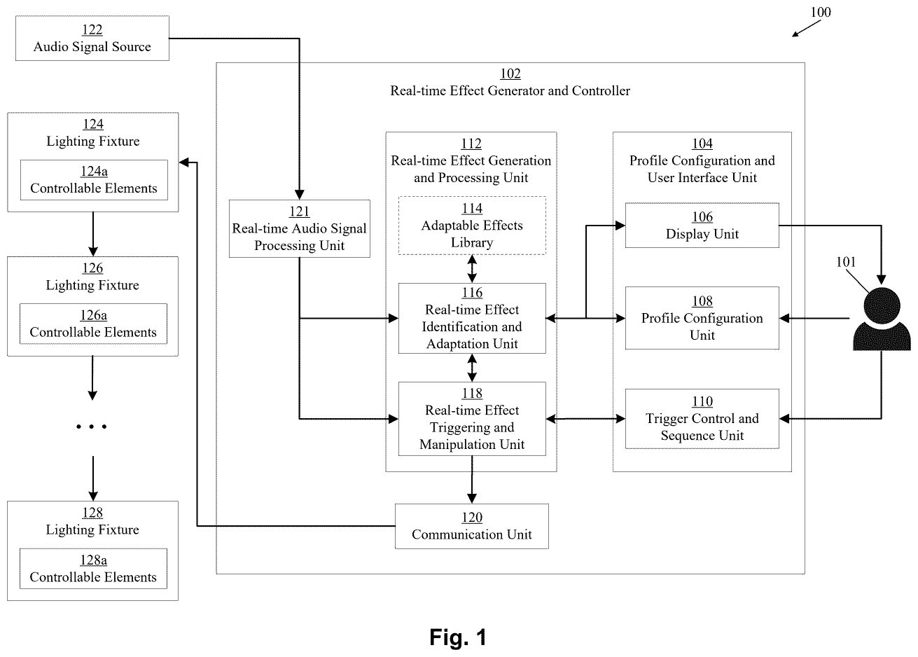

Examples of the present disclosure include a lighting control system configured to control the lighting fixtures to dynamically adjust the lighting effects in real time based on one or more user inputs and/or an audio signal input from an audio signal source. FIG. 1 illustrates a block diagram 100 of a lighting control system 102 (also referred to as a “Real-time Effect Generator and Controller”) according to an example. The lighting control system 102 may include a profile configuration and user interface unit 104, which includes a display unit 106, a profile configuration unit 108, and a trigger control and sequence unit 110. The display unit 106 may be configured to be coupled to a display screen, which may be any kind of display device including, for example, a CRT, LCD screen, LED screen, OLED screen, and so forth. The profile configuration unit 108 and the trigger control and sequence unit 110 may be configured to be coupled to an input device including, for example, a keyboard, keypad, mouse, trackpad, trackball, pointing stick, joystick, touchscreen, microphone or voice controller, and so forth, for receiving user inputs.

The lighting control system 102 may also include a real-time effect generation and processing unit 112, which includes a real-time effect identification and adaptation unit 116 and a real-time effect triggering and manipulation unit 118. In some examples, the real-time effect generation and processing unit 112 may further include an adaptable effects library 114. The lighting control system 102 may further include a communication unit 120 and a real-time audio signal processing unit 121.

The display unit 106 may be bidirectionally coupled to the profile configuration unit 108 and the real-time effect identification and adaptation unit 116. The profile configuration unit 108 may be bidirectionally coupled to the real-time identification and adaptation unit 116. The trigger control and sequence unit 110 may be bidirectionally coupled to the real-time effect triggering and manipulation unit 118. The adaptable effects library 114 may be bidirectionally coupled to the real-time effect identification and adaptation unit 116. The real-time effect identification and adaptation unit 116 may be bidirectionally coupled to the real-time effect triggering and manipulation unit 118. The real-time effect triggering and manipulation unit 118 may be coupled to the communication unit 120. An audio signal source 122 may be coupled to the real-time audio signal processing unit 121. The real-time audio signal processing unit 121 may be coupled to the real-time effect identification and adaptation unit 116 and the real-time effect triggering and manipulation unit 118. The communication unit 120 may be coupled to one or more of an arbitrary number of lighting fixtures (arbitrarily depicted as including a first lighting fixture 124, a second lighting fixture 126, and a third lighting fixture 128). Each of the lighting fixtures 124-128 may include an arbitrary number of one or more controllable elements (arbitrarily depicted as including first controllable elements 124a, second controllable elements 126a, and third controllable elements 128a).

The controllable elements 124a, 126a, 128a may each include one or more lighting devices (for example, an LED lamp) capable of emitting visible light. For example, the lighting fixture 124 may include an array of, say, 50 LED lamps, each of which is one of the controllable elements 124a. In some examples, at least some of the controllable elements 124a, 126a, 128a may include one or more movable or actuatable components (for example, a moving head) mechanically coupled to the respective lighting devices to move the respective lighting devices.

In operation, a user 101 may provide a first user input to the profile configuration unit 108 via a user interface for operating the lighting control system 102. In one example, the first user input may include profile information relating to the lighting fixtures 124-128 to produce the desired dynamic or real-time lighting effects. The profile information may include the respective identity, type, size, configuration, and/or relative spatial position and electrical assortment of each of the lighting fixtures 124-128. The first user input may also include other information, such as a user preference for one or more characteristics of the desired lighting effects (for example, a slow beat, an exciting theme, and so forth).

The profile configuration unit 108 may record the information in the first user input and send the information to the display unit 106 to display feedback information including at least a portion of the information in the first user input that is useful to the user 101. For example, the feedback information can help the user 101 confirm that the correct profile information has been entered.

The profile configuration unit 108 may also send the information in the first user input to the real-time effect identification and adaptation unit 116 to identify a corresponding lighting effect in real time. In one example, the real-time effect identification and adaptation unit 116 may select, in real time, a most suitable preliminary lighting effect from the adaptable effects library 114 based on the information in the first user input. The adaptable effects library 114 may include pre-determined building blocks of various lighting effects that can be adapted in real-time into a preliminary lighting effect of certain characteristic(s). As noted above, the user preference information in the first user input may be used to determine certain characteristic(s) of the preliminary lighting effect to be selected. In other examples, the lighting control system 102 may not include the adaptable effects library 114, and the real-time effect identification and adaptation unit 116 may construct, in real time, the preliminary lighting effect without using pre-determined building blocks.

In some examples, the audio signal source 122 may provide an audio signal input to the real-time audio signal processing unit 121. The real-time audio signal processing unit 121 may process the audio signal input in real time to determine the characteristic(s) of the audio signal using real-time analog and/or digital processing techniques. The real-time audio signal processing unit 121 may then send the characteristic(s) of the audio signal to the real-time effect identification and adaptation unit 116. In one example, when the first user input does not include user preference information, the real-time effect identification and adaptation unit 116 determines the preliminary lighting effect solely based on the characteristic(s) of the audio signal. In another example, when the first user input includes user preference information indicating user-preferred characteristic(s) of the desired lighting effect, the real-time effect identification and adaptation unit 116 may identify a preliminary lighting effect based on both the user preference information in the first user input and the audio signal input. In one example, the real-time effect identification and adaptation unit 116 may identify a preliminary lighting effect that has both the characteristic(s) of the audio signal and the user-preferred characteristic(s). In another example, the real-time effect identification and adaptation unit 116 may identify a preliminary lighting effect by reconciling or overriding a portion of the characteristic(s) of the audio signal based on a portion of the user-preferred characteristic(s) in conflict with the portion of the characteristic(s) of the audio signal. Once the preliminary lighting effect is identified, the real-time effect identification and adaptation unit 116 may send the preliminary lighting effect to the real-time effect triggering and manipulation unit 118.

In some examples, the user 101 may provide a second user input to the trigger control and sequence unit 110 via the communication interface. The second user input may include a trigger signal of a single trigger or a sequence of triggers. Triggers may dictate certain properties of how the lighting fixtures 124-128 are controlled. For example, the triggers may dictate a speed or frequency at which lighting fixtures 124-128 are flashed, rotated, and so forth.

The user 101 may manually input a trigger signal, including starting or stopping a trigger or trigger sequence, resynchronizing or restarting a trigger sequence playback, and/or inserting trigger events, to be recorded by the trigger control and sequence unit 110. Trigger sequences, with the associated timing data required for accurate playback, may be saved to a non-volatile memory (not illustrated) of the lighting control system 102 for future access and playback at any time. The trigger control and sequence unit 110 may send the trigger or trigger sequence from the second user input to the real-time effect triggering and manipulation unit 118. The real-time effect triggering and manipulation unit 118 may manipulate the preliminary lighting effect in real time or dynamically based on the trigger or trigger sequence from the second user input. In one example, the real-time effect triggering and manipulation unit 118 may synchronize the preliminary lighting effect with the trigger or trigger sequence from the second user input in real time to produce a lighting effect signal.

In certain examples, the real-time audio signal processing unit 121 may send the characteristic(s) of the audio input to the real-time effect triggering and manipulation unit 118. The real-time effect triggering and manipulation unit 118 may determine a trigger signal from the characteristic(s) of the audio input. For example, the real-time effect triggering and manipulation unit 118 may determine a trigger or trigger sequence based on one or more transient events of the audio signal. In one example, when the user 101 has not entered a second user input, the real-time effect triggering and manipulation unit 118 may manipulate the preliminary lighting effect solely based on the trigger or trigger sequence from the audio signal. In another example, when the user 101 has entered a second user input, the real-time effect triggering and manipulation unit 118 may manipulate the preliminary lighting effect in real time based on both the trigger or trigger sequence from the audio signal and that from the second user input. For example, the real-time effect triggering and manipulation unit 118 may synchronize the preliminary lighting effect in real time using the triggers or trigger sequences from both the audio signal and the second user input. In some examples, the trigger or trigger sequence from the second user input may override that from the audio signal. Based on manipulating the preliminary lighting effect in real time, the real-time effect triggering and manipulation unit 118 may construct a lighting effect signal and send the lighting effect signal to the lighting fixtures 124-128 via the communication unit 120. In certain examples, the real-time effect triggering and manipulation unit 118 may send the lighting effect signal back to the display unit 106 as feedback information to be displayed to the user 101 via the display unit 106.

In some examples, the lighting fixtures 124-128 may require or prefer a DMX communication protocol. The communication unit 120 may package and transmit the lighting effect signal using the proper DMX protocol and send the lighting effect signal through a unidirectional communication connection from the communication unit 120 to the first lighting fixture 124. In one example, the communication unit 120 may operate as a DMX controller, and the lighting fixtures 124-128 may operate based on the lighting effect signal provided by the communication unit 120. The lighting fixtures 124-128 may be coupled to one another in series in a daisy chain. Each of the lighting fixtures 124-128 may be operated according to a segment of the lighting effect signal in the DMX format. In some examples, the communication unit 120 may include multiple DMX controllers, each communicating to a subset of the lighting fixtures 124-128. In other examples, other communication protocols may be used, including Streaming ACN, ARTNET, DMX RDM, and so forth. In some of these examples, the communication connection between the communication unit 120 and the lighting fixtures 124-128 may not be unidirectional, and some or all of the lighting fixtures 124-128 may not be coupled in series.

The lighting effect signal rendered by the lighting control system 102 may operate the lighting fixtures 124-128 to effectuate lighting effects having desired characteristic(s). In one example, the desired characteristic(s) of a lighting effect may be produced in real time through actions of changing the lighting patterns, speed, frequency, color, and/or brightness of one or more of the lighting devices as well as through physical movement of the actuation components of the lighting fixtures 124-128, such as panning and tilting of moving heads, gobos, filters, zoom lenses, lasers, and so forth. In one example, the lighting effect may be effectuated by synchronizing an action of the first lighting fixture 124 with an action of the second lighting fixture 126.

In various examples, the controller 102 may control the lighting fixtures 124-128 in a synchronized manner. In some examples, the controller 102 may control the lighting fixtures 124-128 to operate in an identical manner. For example, the controller 102 may control each of the lighting fixtures 124-128 to output 500 nm light at the same frequency. In other examples, the controller 102 may control the fixtures 124-128 to operate in different, albeit synchronized, manners.

For example, the action of the first lighting fixture 124 may be light flashing at a frequency of 1 Hz, and the action of the second lighting fixture 126 may be the second lighting fixture 126 outputting a solid (that is, not flashing) light while panning at 1 Hz and synchronized with the flashing of the first lighting fixture 124. Thus, while the two fixtures 124, 126 may not be performing the same action at a given time, they may be synchronized inasmuch as their operation is synchronized to the same 1 Hz frequency.

In some examples, the characteristic of 1 Hz may be determined according to the audio signal and/or the user preference information in the first user input. In another example, the synchronization may be based on a trigger signal constructed based on the audio signal and/or the second user input. In various examples, the first lighting fixture 124 may be of the same type (for example, a strobe) as the second lighting fixture 126. In other examples, the first lighting fixture 124 may be of one type (for example, a strobe), and the second lighting fixture may be of a different type (for example, a gobo). When the first lighting fixture 124 and the second lighting fixture 126 are of different types, the first lighting fixture 124 and the second lighting fixture 126 may be controlled to perform the same action (for example, light flashing at the same frequency) to achieve the desired lighting effect.

Because the lighting effects may be produced by the lighting control system 102 in real time based on the user input(s) and/or audio signal input, the lighting control system 102 enables a real-time, dynamic, and instantaneous visual experience for the user 101 and other observers. For example, rather than the system 102 controlling the fixtures 124-128 based solely on a pre-configured, pre-defined control profile, the system 102 may be capable of determining control signals in real-time, for example, based on an audio signal and, from a human's perspective, with no appreciable delay between the lighting fixtures'124-128 outputs and the audio signal.

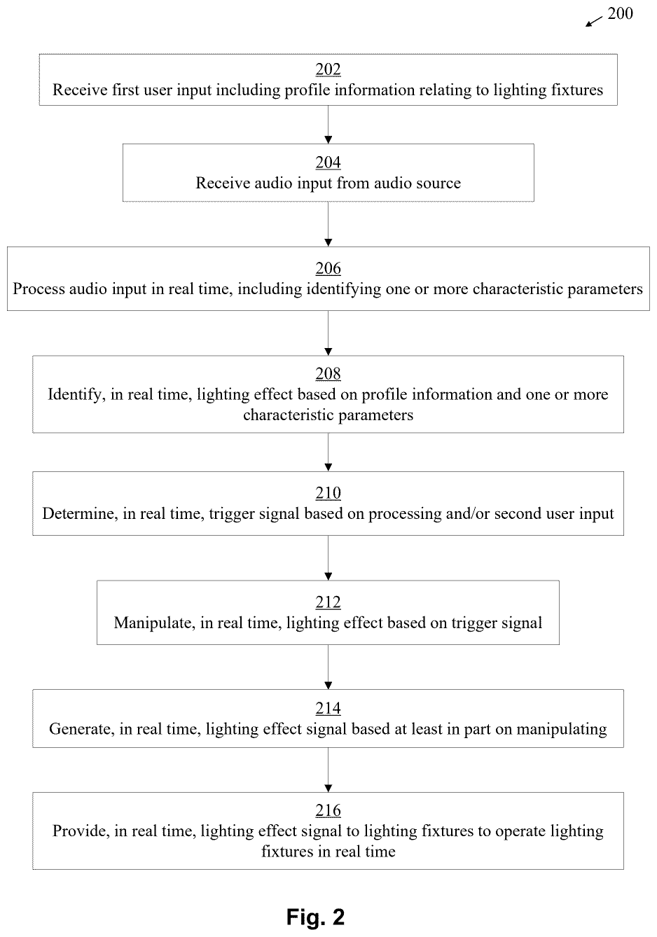

FIG. 2 illustrates a process 200 of operating the lighting control system 102 according to an example. At act 202, in one example, the lighting control system 102 receives a first user input including profile information relating to lighting fixtures (for example, the lighting fixtures 124-128). The first user input may specify a spatial position of the lighting fixtures 124-128 relative to one another. In some examples, the first user input may also include other information, such as user preferences for certain characteristic parameter(s) of a desired lighting effect.

At act 204, in one example, the lighting control system 102 receives an audio (signal) input from the audio (signal) source 122. For example, the real-time audio signal processing unit 121 may include or be coupled to one or more microphones to sense the audio signal.

At act 206, the lighting control system 102 processes the audio input in real time to identify characteristic parameter(s) of the audio input. For example, the real-time audio signal processing unit 121 may identify a frequency, an amplitude, a timbre, a rhythm, or other properties (for example, other musical properties) of the audio input. In another example, the lighting control system 102 may identify the characteristic parameter(s) based on both the audio input and the user preferences in the first user input.

At act 208, in one example, the lighting control system 102 identifies, in real time and/or dynamically, a lighting effect based on the received profile information at the act 202 and the characteristic parameter(s) identified at the act 208. For example, if the audio input has an exciting theme or mood (which the real-time audio signal processing unit 121 may determine based on the characteristic parameter[s], such as frequency and amplitude), the real-time effect identification and adaptation unit 116 may identify a lighting effect corresponding to the exciting theme or mood. The lighting effect should also be compatible with the profile information relating to the lighting fixtures 124-128. In some examples, the lighting control system 102 may select and adapt building blocks from the adaptable effect library 114 that are consistent with the exciting theme or mood to construct the lighting effect. For example, the lighting control system 102 may determine a respective action of each lighting fixture based on the type, configuration, and relative location information of that lighting fixture in the profile information.

At act 210, in one example, the lighting control system 102 determines, in real time or dynamically, a trigger signal based on the real-time processing of the audio input at act 206 and/or a second user input. For example, the real-time effect triggering and manipulation unit 118 may determine the trigger signal. Trigger signals may be used to activate certain effects, such as a change in color of the lighting fixtures 124-128, a movement pattern of the lighting fixtures 124-128, a flashing pattern or frequency of the lighting fixtures 124-128, and so forth. For example, suppose that the system 102 synchronizes the lighting fixtures 124-128 to flash at a frequency of 4 Hz, with the phase of the flashing signal aligned with the volume of the audio signal, such that the lighting fixtures 124-128 flash with each beat of music. The trigger signal may provide the temporal trigger the lighting fixtures 124-128 to flash at the appropriate time, for example, when the beat occurs in the music. The trigger signal may include a single trigger or a series of triggers in a sequence. In one example, the lighting control system 102 may determine a trigger or trigger sequence from transient event(s) of the audio input. In another example, the lighting control system 102 may determine a trigger or trigger sequence from the second user input. For example, the second user input may include the user rhythmically (or, possibly, arrhythmically) pressing a button on the user interface unit 104, where each press corresponds to a trigger. The trigger sequences may be recorded in a non-volatile memory of the lighting control system 102 for future use.

At act 212, in one example, the lighting control system 102 manipulates, in real time or dynamically, the lighting effect based on the trigger signal. For example, the real-time effect triggering and manipulation unit 118 may select or manipulate the lighting effect based on the trigger signal provided by the real-time effect identification and adaptation unit 116. In one example, the real-time effect triggering and manipulation unit 118 may synchronize the lighting effect with the trigger or trigger sequence in the trigger signal.

At act 214, in one example, the lighting control system 102 generates, in real time or dynamically, a lighting effect signal for the lighting fixtures 124-128 based on the previous real-time manipulation of the lighting effect at the act 212. For example, the real-time effect triggering and manipulation unit 118 may generate the lighting effect signal. In one example, the lighting effect signal is a DMX signal including a respective subset for each of the lighting fixtures 124-128 to collectively effectuate the manipulated lighting effect. In another example, the lighting effect signal may be sent according to a different communication protocol. In various examples, act 214 may include generating a different control signal for each of the lighting fixtures 124-128, and the system 102 may provide control signals to each of the lighting fixtures 124-128 in parallel rather than in series. Act 214 may therefore include generating at least one lighting effect signal which may control the lighting fixtures 124-128.

At act 216, in one example, the lighting control system 102 provides, in real time, the lighting effect signal to the lighting fixtures 124-128 to operate the lighting fixtures 124-128 to effectuate the manipulated lighting effect in real time. For example, the communication unit 120 may provide the at least one lighting effect signal to the lighting fixtures 124-128. In some examples, the lighting control system 102 may provide the lighting effect signal to the lighting fixtures 124-128 using a DMX protocol, or a different protocol.

Accordingly, the process 200 provides an example in which the system 102 provides control signals to the lighting fixtures 124-128 in synchronization with (or based on) an audio signal, the control signals being synchronized in real-time with the audio signal. The control signals provided to each of the lighting fixtures 124-128 may each be different; for example, certain lighting fixtures 124-128 may be flashing, while others are solid, and/or may be different colors, and/or may move differently, and so forth. From user's perspective, it may appear as though the lighting display were manually pre-configured to align with the audio signal; however, in various examples discussed herein, the system 102 can dynamically and in real-time provide different, but synchronized control signals to various lighting fixtures 124-128 in synchronization with an audio signal.

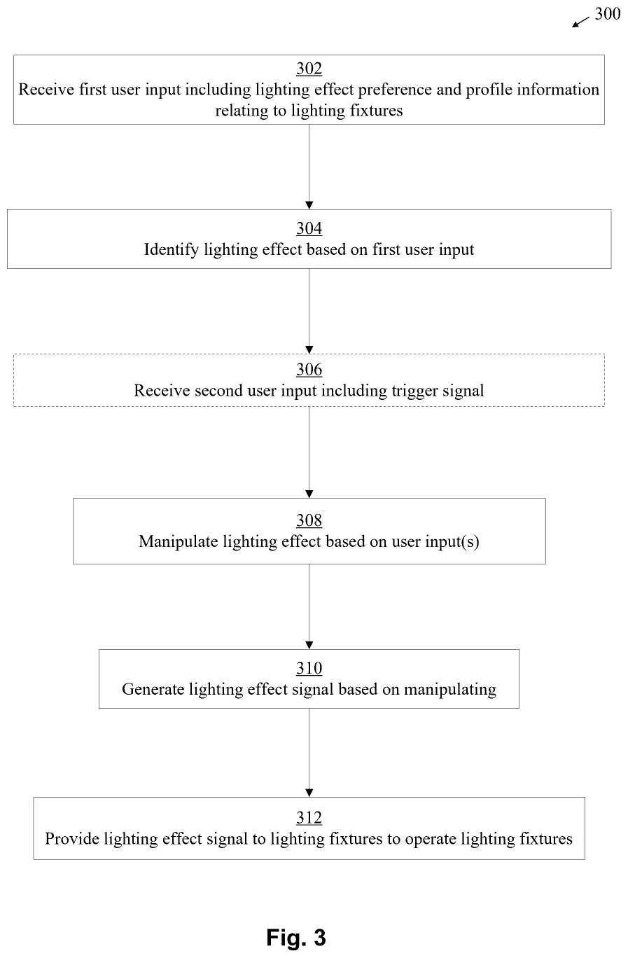

In other examples, however, the lighting control system 102 only uses user input(s) to generate a lighting effect signal to operate lighting fixtures (for example, the lighting fixtures 124-128) in real time or dynamically without an audio input. The lighting effect signal may still be generated dynamically or in real-time inasmuch as the lighting effect signal may be synchronized to a user input provided in real-time. In still other examples, a user may simply select a mood (for example, “slow and steady,” “fast and energizing,” and so forth) without providing a trigger signal, and the system 102 may dynamically control the lighting fixtures 124-128 based on the selected mood. Although the selectable moods may be pre-generated moods, the system 102 nonetheless controls the lighting fixtures 124-128 dynamically inasmuch as the system 102 can generate control signals in real-time to adapt to any number or arrangement of the lighting fixtures 124-128, whereas a non-dynamic system may have a particular set of control signals pre-configured for a pre-determined number and arrangement of lighting fixtures. FIG. 3 illustrates a process 300 of operating the lighting control system 102 without an audio input according to an example.

At act 302, in one example, the lighting control system 102 receives a first user input including user preferences of lighting effect characteristic(s) and profile information relating to the lighting fixtures 124-128. For example, the display unit 106 may display a list of selectable profiles, such as “slow and steady,” “fast and energizing,” and so forth. The user 101 may select a desired profile at act 302.

At act 304, in one example, the lighting control system 102 identifies a lighting effect based on the first user input. For example, the lighting control system 102 may select and adapt building blocks from the adaptable effect library 114 to construct a lighting effect consistent with the user preferences and compatible with the profile information.

Optionally, at act 306, in one example, the lighting control system 102 may receive a second user input including a trigger signal. The trigger signal may include a single trigger or a series of triggers in a sequence. For example, the user 101 may input a trigger to start, stop, pause, or restart the lighting effect at a particular instant. In other examples, the user 101 may input a sequence of rhythmic beats to require that the lighting effect be conformed to the rhythm. For example, the user 101 may press a button or other user-interface element, with each input corresponding to a beat.

At act 308, in one example, the lighting control system 102 manipulates the lighting effect identified at act 304 based on the user input(s). If the second user input including a trigger signal is received at the act 306, the lighting control system 102 manipulates the lighting effect based on the trigger signal in the second user input. For example, the lighting control system 102 may synchronize the lighting effect with the trigger signal in the second user input. If no second user input is received, the lighting control system 102 may use a pre-stored trigger signal for manipulating (for example, synchronizing) the lighting effect. For example, the pre-stored trigger signal may include a trigger signal with a pre-determined frequency.

At act 310, in one example, the lighting control system 102 generates a lighting effect signal based on the manipulation of the lighting effect at the act 308. The lighting effect signal is configured to operate the lighting fixtures 124-128 to effectuate the manipulated lighting effect.

At act 312, in one example, the lighting control system 102 provides the lighting effect signal to the lighting fixtures 124-128 to operate the lighting fixtures 124-128. If the lighting fixtures 124-128 require a DMX protocol, the lighting control system 102 provides the lighting effect signal in the DMX protocol. In other examples, the lighting control system 102 may provide the lighting effect signal according to a different protocol. The lighting effect signal may cause the lighting fixtures 124-128 to take respective actions to effectuate the manipulated lighting effect for the user 101 or other observers. As noted above, the respective actions may be the same or similar for lighting fixtures of different types and may be different for lighting fixtures of the same type. All or some of the acts 302, 304, 306, 308, 310, 312 may be performed in real time or dynamically to enable a real-time experience for the user 101 and other observers. The process 300 may use real-time analog and/or digital processing techniques for real-time control of the lighting control system 100 and the lighting fixtures 124-128.

Various controllers, such as a controller of the lighting control system 102, may execute various processes or operations discussed above. For example, a controller of the system 102 may include or execute the real-time audio signal processing unit 121, the communication unit 120, and/or the real-time effect generation and processing unit 112. The controller may also execute one or more instructions stored on one or more non-transitory computer-readable media, which the controller may include and/or be coupled to, which may result in manipulated data. The non-transitory computer-readable media may include memory and/or storage. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. At least one non-transitory computer-readable medium storing thereon sequences of computer-executable instructions for operating a lighting system including a plurality of lighting fixtures, the plurality of lighting fixtures including a first lighting fixture and a second lighting fixture different than the first lighting fixture, the sequences of computer-executable instructions including instructions that instruct at least one processor to:
receive a first user input including profile information relating to the plurality of lighting fixtures;
receive an audio input from an audio source;
process the audio input in real time, the processing including identifying one or more characteristic parameters of the audio input;
identify, in real time, a lighting effect of the plurality of lighting fixtures based on the profile information and the one or more characteristic parameters;
determine, in real time, a trigger signal based on at least one of the processing of the audio input or a second user input;
manipulate, in real time, the lighting effect based on the trigger signal;
generate, in real time, at least one lighting effect signal based at least in part on the manipulating of the lighting effect; and
provide, in real time, the at least one lighting effect signal to the plurality of lighting fixtures to operate the plurality of lighting fixtures in real time,
wherein operating the plurality of lighting fixtures in real time includes causing the first lighting fixture to take a first action and causing the second lighting fixture to take a second action different than the first action.

2. The at least one non-transitory computer-readable medium of claim 1, wherein operating the plurality of lighting fixtures in real time includes synchronizing the first action and the second action.

3. The at least one non-transitory computer-readable medium of claim 1, wherein the first action and the second action are selected from a group including changing a lighting color, changing a lighting brightness, changing a strobe frequency, and/or panning and/or tilting a moving head, a gobo, a light filter, a zoom lens, and/or a laser.

4. The at least one non-transitory computer-readable medium of claim 1, wherein identifying, in real time, the lighting effect includes adapting, in real time, an adaptable lighting effect stored in an adaptable effect library.

5. The at least one non-transitory computer-readable medium of claim 1, wherein manipulating, in real time, the lighting effect based on the trigger signal includes synchronizing, in real time, the lighting effect and the trigger signal.

6. The at least one non-transitory computer-readable medium of claim 1, wherein the profile information includes respective location information of the plurality of lighting fixtures.

7. The at least one non-transitory computer-readable medium of claim 1, wherein processing the audio input in real time is performed based at least in part on real-time analog signal processing.

8. The at least one non-transitory computer-readable medium of claim 1, wherein:
the first lighting fixture is of a first type,
the second lighting fixture is of a second type different from the first type, and
the profile information includes the first type and the second type.

9. The at least one non-transitory computer-readable medium of claim 1, wherein providing, in real time, the at least one lighting effect signal to the plurality of lighting fixtures includes transmitting the lighting effect signal to the plurality of lighting fixtures using a digital multiplex (DMX) protocol.

10. The at least one non-transitory computer-readable medium of claim 9, wherein at least a subset of the plurality of lighting fixtures are coupled in series.

11. A lighting control system, comprising:
a communication interface configured to be coupled to a user interface;
an audio input configured to be coupled to an audio source;
a control signal output configured to be coupled to a plurality of lighting fixtures including a first lighting fixture and a second lighting fixture different than the first lighting fixture; and
at least one controller coupled to the communication interface, the audio input, and the control signal output and configured to:
receive, via the communication interface, a first user input including profile information relating to the plurality of lighting fixtures;
receive, via the audio input, an audio signal from an audio source;
process the audio signal in real time, the processing including identifying one or more characteristic parameters of the audio signal;
identify, in real time, a lighting effect of the plurality of lighting fixtures based on the profile information and the one or more characteristic parameters;
determine, in real time, a trigger signal based on at least one of the processing of the audio signal or a second user input;
manipulate, in real time, the lighting effect based on the trigger signal;
generate, in real time, at least one lighting effect signal based at least in part on the manipulating of the lighting effect; and
provide, in real time, the at least one lighting effect signal to the plurality of lighting fixtures to operate the plurality of lighting fixtures in real time,
wherein operating the plurality of lighting fixtures in real time includes causing the first lighting fixture to take a first action and causing the second lighting fixture to take a second action different than the first action.

12. The lighting control system of claim 11, wherein the audio input is a microphone.

13. The lighting control system of claim 11, wherein operating the plurality of lighting fixtures in real time includes synchronizing the first action and the second action.

14. The lighting control system of claim 11, wherein the first action and the second action are selected from a group including changing a lighting color, changing a lighting brightness, changing a strobe frequency, and/or panning and/or tilting a moving head, a gobo, a light filter, a zoom lens, and/or a laser.

15. The lighting control system of claim 11, wherein identifying, in real time, the lighting effect includes adapting, in real time, an adaptable lighting effect stored in an adaptable effect library.

16. The lighting control system of claim 11, wherein manipulating, in real time, the lighting effect based on the trigger signal includes synchronizing, in real time, the lighting effect and the trigger signal.

17. The lighting control system of claim 12, wherein processing the audio input in real time is performed based at least in part on real-time analog signal processing.

18. The lighting control system of claim 11, wherein:
the plurality of lighting fixtures includes a first lighting fixture of a first type and a second lighting fixture of a second type different from the first type, and
the profile information includes the first type and the second type.

19. The lighting control system of claim 17, wherein providing, in real time, the at least one lighting effect signal to the plurality of lighting fixtures includes transmitting, in real time, the lighting effect signal to the plurality of lighting fixtures using a digital multiplex (DMX) protocol.

20. A method of operating a lighting system including a plurality of lighting fixtures, the plurality of lighting fixtures including a first lighting fixture and a second lighting fixture different than the first lighting fixture, the method comprising:
receiving a first user input including profile information relating to the plurality of lighting fixtures;
receiving an audio input from an audio source;
processing the audio input in real time, the processing including identifying one or more characteristic parameters of the audio input;
identifying, in real time, a lighting effect of the plurality of lighting fixtures based on the profile information and the one or more characteristic parameters;
determining, in real time, a trigger signal based on at least one of the processing of the audio input or a second user input;
manipulating, in real time, the lighting effect based on the trigger signal;
generating, in real time, at least one lighting effect signal based at least in part on the manipulating of the lighting effect; and
providing, in real time, the at least one lighting effect signal to the plurality of lighting fixtures to operate the plurality of lighting fixtures in real time,
wherein operating the plurality of lighting fixtures in real time includes causing the first lighting fixture to take a first action and causing the second lighting fixture to take a second action different than the first action.
